(19) United States
(12) Patent Application Publication
(10) Pub. No.: US 2010/0248719 A1
(43) Pub. Date: Sep. 30, 2010

(54) SELF-CONFIGURING MAN-MACHINE INTERFACE FOR A COMMUNICATION TERMINAL

(75) Inventor: Hugh Scholaert, Solothurn (CH)

Correspondence Address: DOWELL & DOWELL P.C., 103 Oronoco St., Suite 220, Alexandria, VA, 22314, US

(73) Assignee: AASTRA TELECOM SCHWIEZ AG, Solothurn (CH)

(21) Appl. No.: 12/744,469

(22) PCT Filed: Nov. 17, 2008
(86) PCT No.: PCT/IB08/03885

§ 371 Date: May 24, 2010

Related U.S. Application Data
(60) Provisional application No. 60/989,891, filed on Nov. 23, 2007.

(51) Int. Cl. H04W 24/00

(52) U.S. Cl. 455/434

(57) ABSTRACT

A communication device comprising a man-machine interface operable to be dynamically updated in accordance with predefined conditions, the man-machine interface being updated to reflect services offered by at least one service provider in a particular operating environment.

### BACKGROUND OF THE INVENTION

1. Field of the Invention

The present invention relates to digital networks, and more particularly to dynamically configuring a device to suit a network environment.

2. Description of the Related Art

Most phones include a fixed man-machine interface with a pre-programmed operator-specific menu which provides access to general device settings, user preferences/profiles, and core/standard applications/services, such PIM functions, such as, contacts, calendar, tasks, memos, alarm and calculator.

With the adoption of wireless number portability by carriers or wireless service providers users can now change wireless service providers at will. However, as the mobile devices comprise a fixed interface, it is not always possible to access the plethora of services offered by the different carriers or service providers when a user switches service providers. By design, the fixed interface only provides the best mappings between the user and the device over narrowly predefined boundaries, which inevitably produces subpar performance outside the design envelope. A fixed interface, albeit being somewhat configurable by the user, does not often permit access to the variety of services and/or applications available in the very dynamic and ever-changing environments the user might find themselves in, such as, a GSM/UMTS network, enterprise wireless LAN or public Wi-Fi network. Also, some devices do not function optimally on certain wireless carrier networks, or some services that a customer has with one service provider may not be available, or may not be supported by another service provider.

With the advent of Generic Access Network (GAN) systems, or Unlicensed Mobile Access (UMA) telecommunication systems, cellular networks and wireless LANs have been merged into one seamless service with the dual-mode phone, typically with one user interface, and a common set of network services for both voice and data.

It is an object of the present invention to mitigate or obviate at least one of the above-mentioned disadvantages.

### SUMMARY OF THE INVENTION

In one of its aspects, the present invention provides a communication terminal having a self-reconfigurable man-machine interface for accessing services and applications from a service provider, the man-machine-interface being dependent on predetermined conditions including at least one of a network environment, terminal compatibility with the services and applications, and user preferences.

In another of its aspects, the present invention provides a method for dynamically configuring a communication device in a network environment, the method having the steps of:

(a) sensing and monitoring the network environment;
(b) determining the services and applications available in the sensed network environment;
(c) establishing the compatibility of the communication device with the available services and applications;
(d) providing a suitable man-machine interface for accessing the compatible services and applications; whereby the man-machine interface is updated automatically based on the network environment and/or including other predefined conditions.

In another of its aspects, there is provided a communication device for use in a first network environment and a second network environment, the device having:

a first man-machine interface for operating the device in the first network environment;

a second man-machine interface for operating the device in the second network environment;

wherein the first man-machine interface is automatically replaced by the second man-machine interface when the device is within the second network environment, and

wherein the second man-machine interface is automatically replaced by the first man-machine interface when the device is within the first network environment.

In another of its aspects, the present invention provides a computer-readable medium having a program coded to dynamically update a man-machine interface on a communication device in accordance with predefined conditions.

Advantageously, a real-time dynamically customizable interface between a human and the device continuously maintains a substantially good match between these entities for maximizing usability, delivering the services and applications, and optimizes the performance of the device, thus enhancing the user's experience.

### BRIEF DESCRIPTION OF THE DRAWINGS

Several exemplary embodiments of the present invention will now be described, by way of example only, with reference to the appended drawings in which:

FIG. 1 shows an exemplary communication device;

FIG. 2 shows a schematic diagram of the communication device of FIG. 1;

FIG. 3 shows a communication network, in one exemplary embodiment;

FIGS. 4 (a) and (b) show exemplary display screens for a man-machine interface;

FIG. 5 shows a communication network, in another exemplary embodiment;

FIGS. 6(a) and (b) show exemplary display screens of a man-machine interface;

FIG. 7 shows another exemplary display screen of a man-machine interface; and

FIG. 8 is a flowchart outlining exemplary steps in a method for self-configuring a man-machine interface for the device.

### DETAILED DESCRIPTION OF EXEMPLARY EMBODIMENTS

The detailed description of exemplary embodiments of the invention herein makes reference to the accompanying block diagrams and schematic diagrams, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

Moreover, it should be appreciated that the particular implementations shown and described herein are illustrative of the invention and its best mode and are not intended to otherwise limit the scope of the present invention in any way. Indeed, for the sake of brevity, certain sub-components of the individual operating components, conventional data networking, application development and other functional aspects of the systems may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present invention may also be described herein in terms of screen shots and flowcharts, optional selections and various processing steps. Such functional blocks may be realized by any number of hardware and/or software components configured to perform to specified functions. For example, the present invention may employ various integrated circuit components (e.g., memory elements, processing elements, logic elements, look-up tables, and the like), which may carry out a variety of functions under the control of one or more microprocessors or other control devices. Similarly, the software elements of the present invention may be implemented with any programming or scripting language such as C, C++, Java, COBOL, assembler, PERL, extensible markup language (XML), smart card technologies with the various algorithms being implemented with any combination of data structures, objects, processes, routines or other programming elements. Further, it should be noted that the present invention may employ any number of conventional techniques for data transmission, signaling, data processing, network control, and the like.

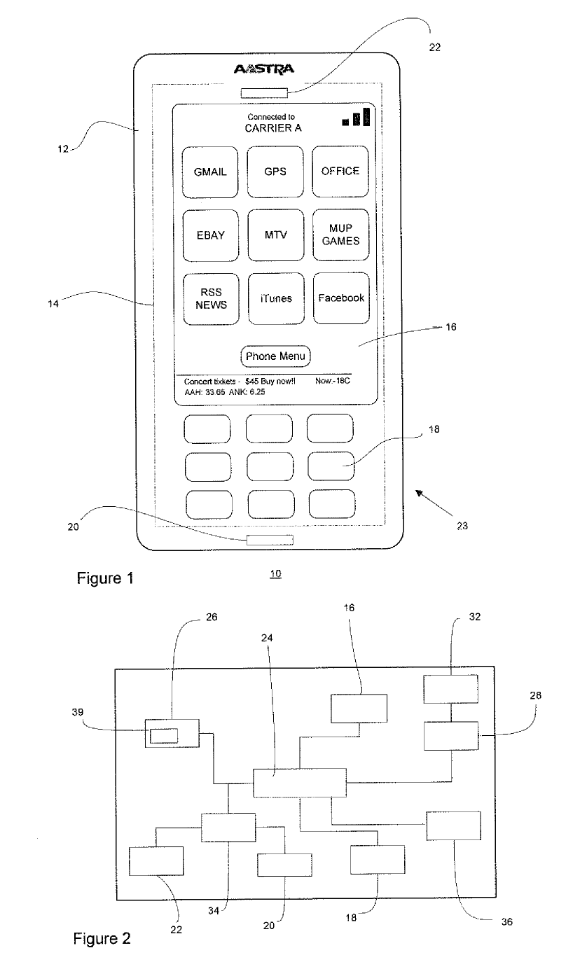

FIG. 1 shows an illustration of an exemplary communications device 10, in accordance with the present invention. The communications device 10 may be a multi-mode terminal, and thus may operate within a plurality of network environments 11, such as, cellular networks, DECT, IEEE 802.11 (Wi-Fi, Bluetooth) networks, IEEE 802.16 (WiMAX) networks, IEEE 802.20 Mobile Broadband Wireless Access (MBWA) networks, and Ultra Wideband (UWB) networks, or any combination thereof. The device 10 includes a housing 12 enclosing a dielectric substrate 14, such as a conventional printed circuit board (PCB) substrate carrying circuitry and components, as will be described below. The device 10 includes input/output devices, such as, display or touch-screen 16, a keypad/keyboard/buttons 18, a microphone 20 and a loudspeaker 22, or other input devices, to form a man-machine interface 23.

The circuitry carried by the circuit board 14 includes a processor 24 (controller or logic means), a machine-readable medium 26, RF circuitry including a transceiver 28, auxiliary I/O device ports 30, and an antenna 32 coupled to the transceiver 28, audio/speech circuitry 34, and a power source 36 including associated circuitry, as shown in FIG. 2. The machine-readable medium 26 generally includes both volatile memory (e.g., RAM) and non-volatile memory (e.g., ROM, Flash Memory, or the like), with an operating system and one or more application programs. Such application programs include phone dialer programs, email programs, browser programs, user ringer tone selection programs, and so forth. The machine-readable medium 26 also includes a client module 39 in communication with the processor 24, to facilitate dynamic configuration of the man-machine interface 23 in accordance with the present invention. The client software module 39 thus includes coded instructions, software or firmware, to enable usage of the device 10 on a plurality of platforms or network environments, by providing the requisite interfaces 23 for services and applications with the specific network environment. The client module 39, or components thereof, may be downloaded and can be installed over-the-air by compatible phones 10, or via a serial port, memory card, IR, cradle, or a cable. The power source 36 may be an external power source, such as an AC adapter or a powered docking cradle that supplements or recharges the batteries.

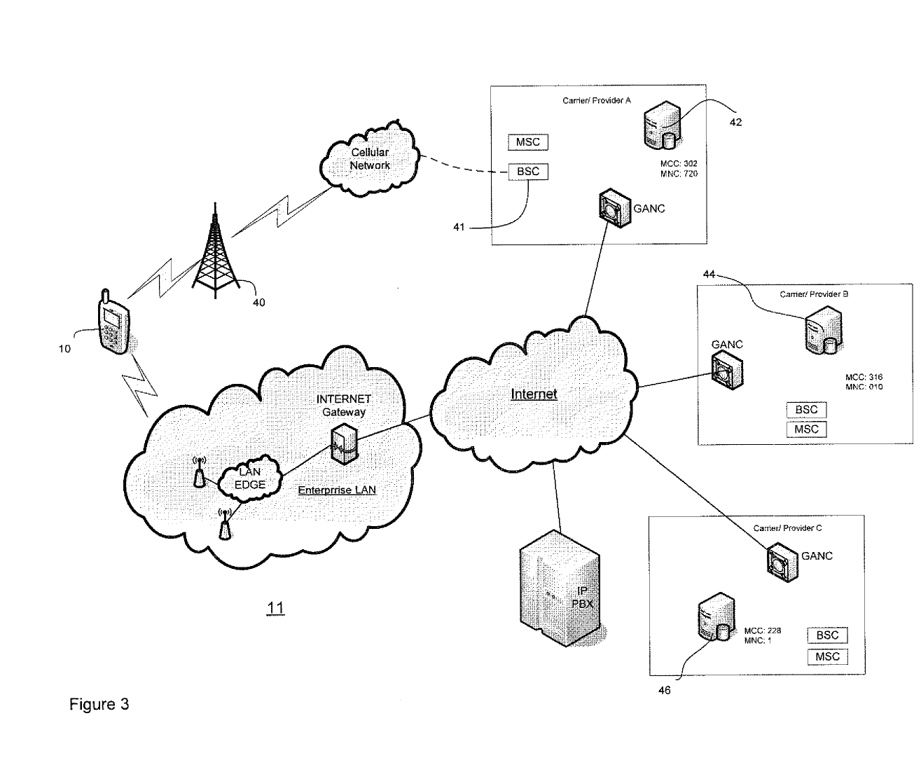

Referring to FIG. 3, there is shown a dual-mode phone 10 communicatively coupled to a communications network 11. The mobile phone 10 includes at least one radio transceiver for operating within the above-noted plurality of network environments 11. For example, in Generic Access Network (GAN) systems, cellular networks and wireless LANs are merged into one seamless service with the dual-mode phone 10. An exemplary phone 10 has four operational modes in a GAN system: “GSM/EDGE Radio Access Network (GERAN)-only” mode which uses cellular networks only; “GERAN-preferred” mode which uses cellular networks if available, otherwise the 802.11 radio is used; “GAN-preferred” mode which uses a 802.11 connection if an access point is in range, otherwise the cellular network is used; and “GAN-only” mode which uses a 802.11 connection only. A GAN client software module is included as part of the client module 39 to relay messages and provide other GAN functionalities to the phone 10.

On the cellular network, the phone 10 communicates over the air with a base station 40, through a base station controller 41, to servers 42 in the core network corresponding to the carrier, such as, carrier/provider A. However, with roaming agreements in place such services may be accessed via other carriers/providers B or C, when the user is not within the home coverage area of carrier/provider A, or due to network congestion within the coverage area. As an example, in a GSM network, roaming is controlled by a Mobile Switching Center (MSC) which manages routing and switching of calls from and to the phone 10. Also coupled to the MSC is a Visitor Location Register (VLR) database which includes information about the phones 10 that are visiting the location areas under the coverage area of the MSC; and a Home Location Register (HLR) database maintains the current location information of the phones 10 belonging to the home location. The servers 42 may thus include the VLR and HLR database servers, including the AAA (Authentication, Authorization, Accounting) server or a content/services server, as is well known in the art.

In one example, in a CDMA environment each roaming partner carrier has the roaming list that contains at least one mobile network code/Mobile country code ((MNC/MCC) and may contain System Identification Number/Network Identification Number (SID/NID) entries, and this roaming list is communicated to the phone 10 and stored in the machine readable medium of the device, and are updated as the MCC/MNCs or change. The phone 10 thus acquires the MCC/MNC or SID/NIDs data directly from the SYNCH channel or the broadcast paging channel. Any MCC/MNCs or SID/NIDs that match the entries in the roaming list are marked as being available in a SYS_AVAIL list. The client module 39 thus receives this SYS_AVAIL list, and as the updates to the roaming list occur, the client module 39 also acquires the available services corresponding to each member of the roaming list. The client module 39 also acquires the corresponding updated man-machine interface 23 associated with each of the MCC/MNC or SID/NIDs. Alternatively, the client module 39 acquires only a URI to the up-to-date man-machine interface 23 for automatic download under predefined conditions, such as, when the connected network signal strength starts to degrade, while other detected network signals become stronger.

Additionally, the client module 39 compares the International Mobile Equipment Identity (IMEI) of the device to the offered or available services to determine device compatibility with the available services. This information may be provided by an IMEI database having records relating to the mobile equipment type, and pointers to device specifications. The client module 39 automatically acquires, via dynamic updates, the necessary applications, software, firmware, and requisite interfaces 23 to adequately facilitate usage of any particular compatible service on the phone 10. The client module 39 also determines the version information of the OS/software/firmware installed on the phone 10, in order to acquire available updates. The dynamic updates may be provided by the carriers or service providers, such as, 3^{rd} party providers, partners or advertisers. Preferably, the dynamic updates are pulled/pushed from a central configuration server maintained by the service provider(s). As part of the man-machine interface 23 dynamic update, the client module 39 also auto-configures the services or applications for use on the compatible phone 10. The auto-configuration may include network settings, device settings, firewall settings, and default user credentials. For example, the network GPRS settings are generally provided by default by the service provider; however, some services require manual entry of these settings, such as the Access Point Name (APN) or gateway settings. The client module 39 thus acquires such configuration settings data and provides it to the appropriate services, for auto-configuration of the phone 10. Generally, the user can sign up for services with the service provider via the phone 10, the service provider storefront (online or bricks & mortar); or as part of a service/subscription plan, including IM, SMS, email, fax or snail mail. Typically, the only input required are user credentials when using the service for the first time, otherwise an auto-login process is enabled for subsequent access.

The carrier/provider A includes a plurality of services available to users and accessible via compatible devices, such as phone 10. Therefore, the services may depend on the user's service plan or subscription. Also, carrier/provider C may offer a different set of services from other carrier/providers A or B. As an example, a suitably qualified phone 10 may receive services from carrier/provider A, such as, mobile email, instant messaging, WAP, Navigational Systems or GPS. In contrast, carrier/provider C may include video calling, multimedia streaming, gaming, live auctions, digital library access, anti-virus/anti-spam services, firewall, VPN, encryption, access to 3^{rd} party services, hosted apps, device data backup, e-commerce, in addition to the services provided by carrier/provider A.

Typically, each carrier/provider A, B or C includes a unique interface, suitably laid out to access its services, while the user options/device options and related menu items remain the same despite the carrier/provider for the phone 10. The phone menu provides access to general device settings, user preferences/profiles, and core/standard applications, such PIM functions, such as, contacts, calendar, tasks, memos, alarm and calculator. Therefore, when a user transitions from a network operated by carrier/provider A to a network operated by carrier/provider C, the man-machine interface 23 is automatically switched to reflect the services offered by carrier/provider C. The client module 39 thus monitors the current network environment 11, detects or anticipates hand-overs between networks, to cause the phone 10 to configure itself, such that the man-machine interface 23 reflects the services offered by the new network provider. The man-machine interface 23 transition may be set to occur under certain predefined conditions; automatically or with prior notification to the user, or due to the change in primary carrier/provider given the ease provided by wireless number portability.

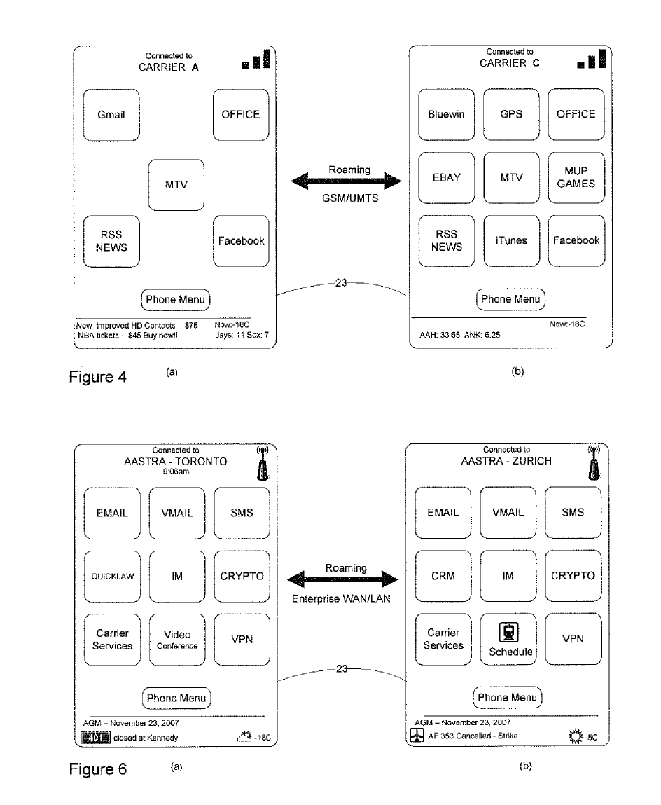

FIGS. 4(a) and 4(b) show exemplary display screens for a man-machine interface 23 corresponding to services offered by two different carriers, and each man-machine interface 23 being suitably configured for a single phone 10. The interfaces 23 include a plurality of thumbnails/buttons/icons or text, corresponding to the available services and applications specific to a carrier/service provider. In addition, the client module 39 also allows the phone 10 to integrate seamlessly with an enterprise PBX system. Advantageously, the remote user has access, through the phone 10, to the entire spectrum of enterprise services available on an office terminal, such as consolidated voicemail, fax, email (IMS), conferencing, four or five digit transfer, caller-id, and single number reachability, and so forth. As an example, enterprise PBX services may be accessed via the “OFFICE” thumbnail/button on the man-machine interface 23.

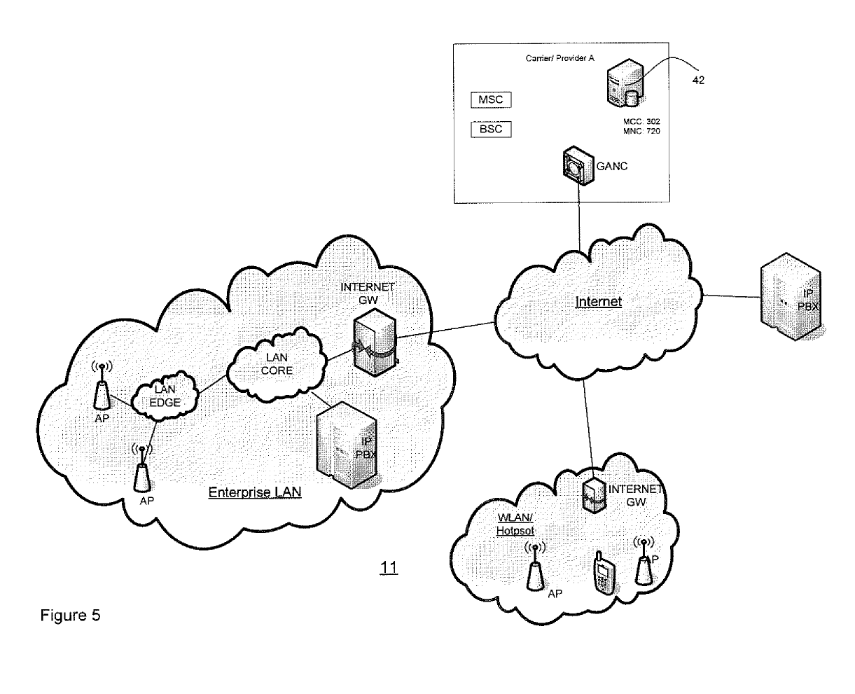

Referring now to FIG. 5, there is shown a dual-mode phone 10 that has migrated into a LAN from a cellular network. In this exemplary embodiment, the phone 10 is communicatively coupled to the servers 42 in the core network of the carrier, via the LAN and the Internet, in order to access the core network services, in the GAN operation mode. The phone 10 establishes Internet Protocol (IP) connectivity with a wireless access network node, such as a GAN controller (GANC), via a gateway on the LAN. Thereafter, the device initiates a registration request message towards the wireless access network node. The GANC functions as a base station controller in the GSM/GPRS network, and thus translates the signals coming from the phone 10 to make it appear to be coming from a base station, so that seamless hand-off between cellular networks and UMA can occur. Therefore, the user is able to access the same mobile core network services from the carrier content/services server 42 while connected to the LAN, and so the man-machine interface 23 is configured to reflect the services offered by the carrier/service provider.

In another exemplary embodiment, the phone 10 is coupled to the LAN which provides a variety of LAN services to the user, such as an enterprise LAN environment, with a LAN edge and LAN core. The phone 10 automatically performs a handoff from the cellular network to the enterprise LAN and maintains seamless continuity of any telephony applications, or data services, in progress. Upon detection of the LAN Service Set Identifier (SSID) (for which the phone 10 is preferably preconfigured for connecting thereto), the phone 10 establishes a secure IP connection through an access point at the LAN edge coupled to the LAN core. The client module 39 causes the man-machine interface 23 to be updated in order to reflect the new operating network environment, as shown in FIGS. 6 (a) and (b). The man-machine interface 23 thus presents the available services from the enterprise, based on phone 10 compatibility or user preferences. Such services may include, but are not limited to, PBX features (extension dialling, speed dial, group calling, call forwarding, conferencing, etc), Instant Messaging, Video Messaging, vmail, fax (IMS), including tools for CRM, collaboration, document management, inventory, presentation, applications, or encryption.

In another example, an enterprise WAN user at a primary geographical location (Office A) uses a device A, such as dual mode phone 10, to access subscribed services available via the enterprise. The user stores his/her device A configuration settings, such as port assignments, registration information, dial plan, NTP time settings, soft-keys, XML services and applications, registration information, usernames and passwords, phone book directory, speaker volume settings, man-machine interface 23, in a central depository, such as a configuration server, with a challenge/response scheme, such as a PIN. In the event that the user is now at a secondary geographical location (Office B), the user using a device B enters his/her PIN to retrieve the stored configuration settings, including the man-machine interface 23. The client module 39 automatically configures the device B to represent the man-machine interface 23 attributed to the unified communication services to which the user is a subscriber such that the configuration settings, including the man-machine interface 23 and related services, are able to “follow” the user within the enterprise. Should device A and device B be identical, or have similar specifications, then the man-machine interface 23 for device B is identical or substantially identical to the man-machine interface 23 for device A, otherwise only services compatible with device B are available.

In yet another example, each office within the enterprise WAN/LAN may include its own man-machine interface 23 to access services available to that office, or each department has a man-machine interface 23 specific to that department. As an example, the man-machine interface 23 may be dependent on the office LAN SSID, department LAN SSID, the user's position with the organization, or the user's identification (PIN). As an example, a device A, previously used by a recently terminated employee A in the legal department is provisioned to a new employee B in the marketing department; the device A with a man-machine interface 23 for the legal department is automatically updated and configured to present a man-machine interface 23 suited for marketing services, by entering the new employee B′s PIN.

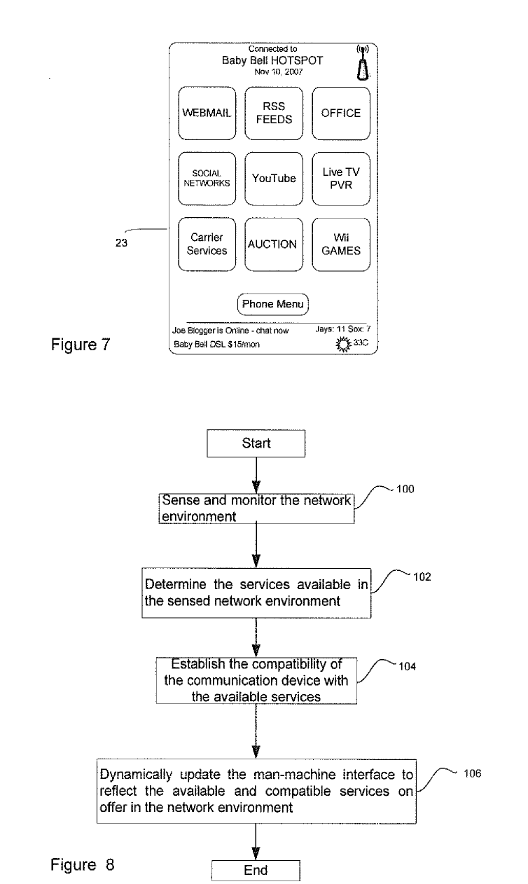

In yet another embodiment, a phone 10 migrates into a non-enterprise (home or small business) LAN environment, as also shown in FIG. 5. The non-enterprise wireless LAN may be a public Wi-Fi network accessible via an access point or a hotspot. As such, the non-enterprise wireless LAN may be operated by broadband operators (ISPs, WISPs, and VoIP SPs), mobile operators, and hotspots may be found at varying locations, such as, a university, hospital, airport, hotel, SOHO, school, prison, government, library, or a municipality. Provided that the user has previously subscribed to the Wi-Fi services available from the service provider, the phone 10 automatically performs a handoff from the cellular network to the Wi-Fi network Upon detection of the LAN SSID, the client module 39 causes the man-machine interface 23 to update in order to reflect the services on offer on that particular Wi-Fi network, as shown in FIG. 7. The man-machine interface 23 thus presents the available services based on phone 10 compatibility or user preferences. Such services may include Instant Messaging, MMS, IMS, Auctions, Social Networks, LiveTV/PVR, Real-time Multi-User Games, Integrated Music Library, RSS feeds, Webmail, WAP, Push-to-talk, and so forth. Compatible services available via the enterprise network or IP PBX, or the cellular network providers, are also available via the man-machine interface 23. For example, voice calls may be routed via the enterprise IP PBX or public IP PBX, instead of the cellular network

A user may also roam between Wi-Fi networks operated by different service providers. Preferably, the phone 10 includes a list of roaming partners. Each Wi-Fi network operator or service provider includes a plurality of services available to users and accessible via compatible phones 10, the services may depend on the user's service plan or subscription. Typically, each service provider may offer a different set of services from other service providers, and thus may include dissimilar customized man-machine interfaces 23 to access those particular services. By having a customized man-machine interface, the service provider is able to provide and control the services, content and advertising channels, and/or allow partnering with 3^{rd} parties to enhance the user experience and generate revenues.

As the updates to the roaming list occur, the client module 39 also acquires the available services corresponding to each member of the roaming list. The client module 39 may also acquire the corresponding updated man-machine interface 23 associated with each of the SSIDs. Alternatively, the client module 39 acquires only a URI to the up-to-date man-machine interface 23 for automatic download under predefined conditions, such as, when the network signal strength begins to degrade, while other stronger network signals are detected. Typically, the client module 39 acquires all the interfaces 23 corresponding to the members of the roaming list. Therefore, when client module 39 acquires a newly detected network's SSID data from the processor via the transceiver, the client module 39 dynamically presents a man-machine interface 23 corresponding to the SSID, depending on predefined rules or user preferences. Additionally, the client module 39 compares the IMEI of the phone 10 to the offered or available services to determine the phone 10 compatibility with the available services.

In yet another exemplary embodiment, the network environment 11 may be a SOHO network. In accordance with the teachings of this invention, upon detection of the SOHO SSID, the device man-machine interface 23 is updated to reflect the services offered within the SOHO network. As an example, the services may include digital music library, home automation/management, home security, PVR, and so forth.

It should be noted that, whether the phone 10 is in an enterprise or non-enterprise LAN (public Wi-Fi, SOHO, and so forth), mobile core network services may still be accessed via a “CARRIER SERVICES” thumbnail/button on the man-machine interface 23 via the GANC, using the method described above. The man-machine interface 23 thus presents the available services from the enterprise, based on phone 10 compatibility or user preferences. Also, a phone 10 in a non-enterprise LAN may still access enterprise services and enterprise PBX features, via the “OFFICE” thumbnail/button to reveal an appropriate enterprise man-machine interface 23.

The flowchart of FIG. 8 shows the exemplary steps for a method for dynamically configuring a communication device 10 in a network environment, the method having the steps of sensing and monitoring the network environment 11 (step 100). The client module 39 acquires the network information data, such as, SID/NID, MNC/MCC or SSID data. In the next step (102), the client module 39 ddetermines the services available in the sensed network environment, and establishes the compatibility of the communication device 10 with the available services, in step 104. Lastly, the client module 39 dynamically updates the man-machine interface 23 to reflect the available and compatible services on offer in the network environment 11 (step 106). The dynamic updates are performed automatically, or are based on predefined conditions, such as, user preferences. It should be noted that some services may be transferable from one carrier/service provider to another, that is, should the user already have the required to credentials for a service, e.g. RSS NEWS for a particular source, then the user need not sign-up again despite the user being on a different network.

Advantageously, the man-machine interface 23 is intuitive to use, and preferably the services, content and features are suitably designed to increase “stickiness”, and thus may increase the ARPU from higher-end data plans for the carrier/service provider. By accessing these services directly, instead of via a browser, the user enjoys an enhanced experience through faster data transfer speeds and substantially fewer keystrokes. Additionally, automatic updates of services, content, and the man-machine interface 23 create an “always on” mobile experience which improves subscriber satisfaction.

In addition to the services described above, advertising banners/pop-ups/text, partnered services, may also be presented, including other informational updates such as weather, sports scores, stock quotes or tickers, public broadcast announcements, road conditions, transit information, and so forth. The man-machine interface 23 is customizable to include, for example, customization includes, but is not limited to, skins, menus, thumbnail images for menu items, language, services, backgrounds, application and system icons, fonts, animations and sounds, themes/skins, display preferences, display priority, geographically based preferences or displays, transitions between interfaces, content, advertising/info update preferences, alarms or notifications (ringtones/videotones).

In yet another embodiment, the man-machine interface 23 reflects the services to which the user is subscribed, and may also include services that the user might be interested in subscribing to, based on demographics, historical service-usage data, or user preferences. Also, newly updated services or new services may be presented in a unique manner via the man-machine interface 23 to grab the user's attention. For example, the new services may include a “flashing”, or overlayed, thumbnail image/button, a 3-D image, or an animation with/or without audio. The man-machine interface 23 may also include multiple windows on the display screen, selectable menus, and directional keys for navigation and/or selection of menu items or services.

The device 10 may be fixed or mobile, and includes, but is not limited to, mobile phones, IP terminals, H.323 terminals, DECT terminals, SIP-DECT terminals, PDAs, digital cameras, PCs, MP3 players, soft phones, game consoles, ATAs, IPTVs, TVs, remote controls, projectors, set-top boxes, Sat-Nay systems, multimedia devices, network appliances, or any combination(s) thereof.

The communication network 11 can include a series of network nodes (e.g., the clients and servers) that can be interconnected by network devices and wired and/or wireless communication lines (such as, public carrier lines, private lines, satellite lines, etc.) that enable the network nodes to communicate. The transfer of data between network nodes can be facilitated by network devices, such as routers, switches, multiplexers, bridges, gateways, etc., that can manipulate and/or route data from an originating node to a server node regardless of dissimilarities in the network topology (such as, bus, star, token ring, mesh, or hybrids thereof), spatial distance (such as, LAN, MAN, WAN, Internet), transmission technology (such as, TCP/IP, Systems Network Architecture), data type (such as, data, voice, video, multimedia), nature of connection (such as, switched, non-switched, dial-up, dedicated, or virtual), and/or physical link (such as, optical fiber, coaxial cable, twisted pair, wireless, etc.) between the correspondents within the network.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises,” “comprising,” or any other variations thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. For example, the steps recited in any of the method or process claims may be executed in any order and are not limited to the order presented. Further, the present invention may be practiced using one or more servers, as necessary. Thus, the preceding detailed description is presented for purposes of illustration only and not of limitation, and the scope of the invention is defined by the preceding description, and with respect to the attached claims.

1.-50. (canceled)

51. A method for dynamically configuring a communication device in a network environment, the method comprising the steps of:
(a) sensing and monitoring said network environment;
(b) determining available services and applications in said network environment;
(c) establishing the compatibility of said communication device with said available services and applications;
(d) providing a suitable man-machine interface for accessing said available services and applications based on compatibility; whereby said man-machine interface is updated based on said network environment, available services and applications and compatibility.

52. The method of claim 51 wherein said man-machine interface is provided automatically based on said network environment.

53. The method of claim 51 wherein said man-machine interface is provided automatically based on said predefined conditions.

54. The method of claim 51 wherein said man-machine interface is provided based on said user preferences.

55. A communication device for use in a first network environment and a second network environment, the device comprising:
a first man-machine interface for operating said device in said first network environment;
a second man-machine interface for operating said device in said second network environment;
wherein said first man-machine interface is automatically replaced by said second man-machine interface when said device is within said second network environment, and
wherein said second man-machine interface is automatically replaced by said first man-machine interface when said device is within said first network environment.

56. The communication device of claim 55, wherein said first network environment is a cellular network, and said first man-machine interface provides services and applications available from said cellular network operator; and
wherein said second network environment is a wireless LAN, and said second man-machine interface provides services and applications available from said wireless LAN operator.

57. The communication device of claim 55, wherein said first network environment is a first cellular network, and said first man-machine interface provides services and applications available from said first cellular network operator; and
wherein said second network environment is a second cellular network, and said second man-machine interface provides services and applications available from said second cellular network operator

58. The communication device of claim 55, wherein said first network environment is a first wireless LAN, and said first man-machine interface provides services and applications available from said first wireless LAN operator; and
wherein said second network environment is a second wireless LAN, and said second man-machine interface provides services and applications available from said second wireless LAN operator.

59. The communication device of claim 58, wherein each of said man-machine interfaces is updated to include a plurality of thumbnails/buttons/icons or text, corresponding to the available services and applications specific to the network environment.

60. The communication device of claim 55 comprising:
a client module for monitoring the network environment and for anticipating hand-overs between said network environments based on the respective signal strength corresponding to the first network environment and the second network environment, the client module causing the communication device to select one of said network environments and updating one of said man-machine interfaces to reflect the services and applications offered in the selected network environment.

61. The communication device of claim 60, wherein the transition between said man-machine interfaces transition occurs automatically.

62. The communication device of claim 60, wherein the transition between said man-machine interfaces occurs under predefined conditions.

63. The communication device of claim 60, wherein said man-machine interface is customizable.

64. The communication device of claim 60, wherein each network environment operator provides and controls the services, applications, content and advertising channels, and allows partnering with 3^{rd} parties to enhance the user experience and generate revenue.

65. The communication device of claim 60, wherein the client module acquires updates to applications, software, firmware, and man-machine interfaces to facilitate usage of said device.

66. The communication device of claim 65, wherein said updates occur automatically.

67. The communication device of claim 66, wherein said updates are pulled or pushed from a configuration server maintained by any one of said network environment operator, a service provider, a partner, 3^{rd} party provider, or an advertiser.

68. The communication device of claim 60, wherein said client module auto-configures the services or applications for use on the compatible device.

69. The communication device of claim 60, wherein said wherein said client module auto-configures network settings, device settings, firewall settings, and default user credentials.

70. A computer-readable medium comprising coded instructions for dynamically configuring a device in a network environment, said coded instructions comprising:
(a) a first set of instructions coded to sense the network environment and determining services and applications available for said network environment;
(b) a second set of instructions coded to determine the capabilities of said device;
(c) a third set of instructions coded to establish the compatibility of the device with said available services and applications;
(d) a fourth set of instructions coded to provide a suitable man-machine interface for accessing compatible services and applications;
whereby said man-machine interface is updated based on the network environment and/or including other predefined conditions.
